(19) United States
(12) Patent Application Publication
(10) Pub. No.: US 2003/0128754 A1
(43) Pub. Date: Jul. 10, 2003

(54) Motion estimation method for control on the basis of scene analysis in video compression systems

(76) Inventors: Hiroshi Akimoto, Kawasaki-shi (JP); Georgiy N. Vostrov, Kawasaki-shi (JP)

Correspondence Address: William L. Haynes., Garrison & Associates PS, Suite 3300, 2001 Sixth Avenue, Seattle, WA, 98121-2522, US

(21) Appl. No.: 10/338,984

(22) Filed: Jan. 9, 2003

Related U.S. Application Data
(60) Provisional application No. 60/347,400, filed on Jan. 9, 2002.

(51) Int. Cl. H04N 7/12

(52) U.S. Cl. 375/240.02; 375/240; 375/240.08

(57) ABSTRACT

The method for video compression to a high degree on the basis of the calculation of motion estimation is based on obtaining complete information and on the structure and dynamic of the inter-frame interaction and its use in video compression procedures. Video films are presented as a series of scenarios, which are examined as a series of scenes, dynamically replacing each other. Scene analysis is presented as a labeled graph of relationships between subjects. Coding of scenes permits consideration of their structure and the structure of subjects by using an adaptive metric. An increase in the degree of compression and improvement in the quality of the images obtained by removal of unwanted artifacts during compression are permitted. The disclosed method checks for conflicting situations during motion estimation, and its reverse-recursive structure provides for their removal. The stochastic nature of the criteria for the proximity of the object is also considered.

### CROSS-REFERENCE TO RELATED APPLICATION(S)

This application claims priority from U.S. Provisional Patent Application No. 60/347,400, entitled “Motion Estimation Method for Control on the Basis of Scene Analysis in Video Compression Systems,” filed Jan. 9, 2002.

### FIELD OF INVENTION

The given invention relates to and integrates instruments for resolving the creation of control systems using motion estimation components on the basis of the dynamic analysis of the structure of images as scenes, the structures of which interact among themselves and with the medium.

### BACKGROUND OF THE INVENTION

The international committee “Motion Picture Experts Group” is concerned with the standardization of instruments for the compression and decompression of images. The standard determines the form of the presentation of the image code and the method of its reproduction. It covers the line format of television and monitor displays.

In accord with the MPEG standards, images are presented as matrices of “layers of macro-units,” each of which contains a specific number of parts of an image in the form of macro-blocks, each of which measures 16×16 pixels. A series of compressed images is divided into two sub-sets. The first is a subset of reference images based on entropy coding, methods for quantization, and the coding of which methods of discrete cosine transformation are found in MPEG(2) and MPEG(4). The second subset contains frames in which temporal redundancy is removed by means of estimation and compensation of motion.

Images as functions of two variables belong to the class of functional spaces with characteristics, the approximation of which by trigonometric orthonormal functions has poor frequency localization. This means that quality high-degree compression of images on the basis of discrete-cosine transformation has limits in the range of non-high-degree compression.

Transient fragments of images are compressed using methods based on a discrete-cosine transformation. As a rule, this results in complex, difficult to remove distortions. Motion estimation procedures are used to attain high-quality compression to the desired degree, thereby yielding a good result if the reference images possess a high quality of compression. However, when using the discrete-cosine transformation, this is only attained in degrees of compression that are not very high (on the order of 20).

MPEG-4 encounters still greater problems in those cases where it is necessary to ensure a high degree of video compression (on the order of 200), which can be attained only by means of the active use of all motion estimation possibilities. Traditionally, such a degree of video compression for frames of 320×256 pixels, for MPEG-4 at a level of quality for films with complex dynamics, it is not yet attainable.

There are several reasons for this. Frames with an “interpolated” format are distributed between two reference frames, that possess the formats “intra” and “predicted” respectively. Frames of the “interpolated” type are formed with the aid of the identification of blocks in the aforementioned frames that have minimal displacement in relation to the given block with minimal approximation error. MSE or PSNR usually are used as a measure of the degree of proximity of the blocks that generally do not adequately reflect the visual similitude of the blocks. The selection of approximating blocks is implemented on the basis of an additional criterion, whereby the entropy of vectors of displacement is minimal, which ensures a maximal degree of compression at the entropy encoding stage.

The congruence of the displacement of the blocks leads to an unbalancing of the visual images of adjacent blocks, and as a result to a greater number of unwanted artifacts. The latter, through transfer from frame to frame, leads to complete disruption of the images or of their individual fragments. In order to remove an accumulation of artifacts, re-encoding of blocks by the discrete-cosine transformation method is actively used in the MPEG-2 and MPEG-4. As a rule, re-encoding is implemented with rather significant errors.

### SUMMARY OF THE INVENTION

[The disclosed method for control of motion estimation is based on the use of wavelet technology for compression with a low level of loss of information upon recovery of the images. Inter-frame interaction in video films is calculated by means of examination of individual images as scenes with subsequent classification into scenarios resembling them. Per the character of the correlation relationship between frames of a scenario, the global model for control using motion estimation is determined. Different variants for models of control with inter-frame interaction are shown in FIG. 4.][With the goal of effective analysis of scenes, is presented for presenting scenes in the form of graphs of the interaction of objects of scenes. An example of the graph is in FIG. 1. After the adjustment of the model parameters in accordance with the disclosure herein, the subsequent compression of the scenario images is implemented.

For each compressed image the level of information loss is determined according to its regenerated depiction. If it exceeds the established threshold, then a repeat encoding of the image is made with altered values for the parameters of adjustment of the model for control with motion estimation, and the situation is also possible where the entire model for control with motion estimation is altered.

At the end of the compression of the entire video the visual characteristic of the video and the average level of information loss are checked.]

### BRIEF DESCRIPTION OF THE DRAWINGS

FIG. 1 is a graph showing the objects in the same video scene that have been assigned different variants of analysis for local control with inter-frame interaction.

FIG. 2 is a graph showing the blocks in a video scene.

FIG. 3 is a graph depicting the relationship between blocks in a video scene FIG. 4 depicts examples of different models for the global control of motion estimation.

FIG. 5 is a comparison of the MSE value of two image blocks from a video scene.

FIG. 6 depicts the method of isolating an object in a video scene as taught by the current invention.

FIG. 7 is a graph of the Correlation Coefficients for a video film.

FIG. 8 shows examples of simple objects of the approximating and approximable blocks and the correspondences between them.

FIG. 9 shows the approximating and approximated block matching in a video scene as taught by the current invention.

FIG. 10 is a video frame showing the distribution of blocks requiring re-encoding and consolidated blocks of re-encoding.

### BEST MODE OF CARRYING OUT THE INVENTION

The invention will now be described in preferred embodiments by reference to the drawing figures where appropriate. Each film is interpreted as a special class of database, in which, with a given degree of adequacy and the necessary complete form of presentation, information about some part of the real or intellectual world is expressed. Such a type of database may be classified as multivariate. It possesses several functional values: the transfer of information to consumers in the form of a video film for leisure, the distribution of information or the deepening of knowledge in a particular area, and other functions. Elements of such databases may be developed as in the case of classic relational, object-oriented, network, distributed databases.

The development of Web technologies, the creation of an electronic business system, medical databases and aerocosmic information attest to the use of video in such aspects. Upon examination of video film from these points of view, the problem of video compression acquires additional peculiarities. In decoding it is important to obtain not only quality video film for viewing perception, but also acceptable losses of information that are not connected with those parts or fragments of frames which carry important information or new knowledge about the given subject range.

Such a point of view and the approaches and requirements deriving therefrom for compression and decoding procedures determine the necessity of creating video compression methods, which would to a maximum degree reflect the structure of the video, the dynamic of the change of the blocks of frames, their qualities and interconnections. This is desirable not only purely from a viewer's point of view, but also in the transmittal of a sequence of web sites along Internet channels, mobile video links, and in the creation of a system of electronic business on a real-time scale.

For the creation of a video compression and decoding system, in which rigorous demands are made, it is proposed to make a preliminary analysis of each video film based on the requirements placed on the compression and decoding procedure. The task of exploratory pre-processor analysis is to describe the structure of the video and the dynamics of change of individual qualities and components.

The structural analysis of the video films has a four-level hierarchical structure. A sequence of frames reflecting the dynamic of change of the isolated subject range is subject to one law, referred to herein as the local scenario. A sequence of local scenarios that form a video film, and the law of these scenarios replacing of each other, referred to herein as the global scenario. The dynamic of change of all parameters and the qualities of the objects of the subject range determine the local scenario. Different subject ranges may be connected with different scenarios. Therefore the global scenario reflects the dynamic of transition from one subject range to another, or the dynamic of transition of subject ranges from one state to another.

If one designates as the subject range of the real or intellectual world, some part of it that is isolated with the aid of a system of limitations that satisfy the given conditions. The object of a subject range would be those of its components that may be constructed from some sub-set of elementary objects with the aid of a given set of operations. The same subject range may be allocated to a set of objects by different methods. The choice of a method of presentation of the subject range in the form of a set of objects depends on the character of the use of the isolated objects in the analysis of the structure of the scenes and the dynamic of their change.

If one looks at a simpler model of scene analysis, based on a block ideology for separation of objects, and calls a rectangular block of any size an object of the subject range. Such a perspective on the objects may be explained by the fact that any block may be examined as a subject range, inserted into the subject range, connected with the given image (frame). Thus one can proceed from the assumption that any subject range itself is an object. The selected model of a subject range corresponds well with the methods disclosed herein for quality high-degree video compression based on wavelet compression methods and block analysis of structure, processing and calculation of inter-frame interactions, called motion estimation.

The degree and quality of video compression is determined by the degree and quality of the reference frames, made possible on the basis of wavelet methods of compression of static images and the degree and quality of compression of approximating images in a sequence between reference frames. The effectiveness of the compression algorithms for the images with estimation of inter-frame interaction is determined by the effectiveness of the system for control using motion estimation procedures on the basis of information that reflects the dynamic of change and interaction of the objects represented as blocks. One system for control of compression procedures on the basis of motion estimation is based on the use of a graph of the relationships between the blocks.

When constructing the graph, an object is called elementary if it cannot be broken down into simpler objects. In the given interpretation of the understanding of the object, pixels are elementary objects. Such elementary objects are described by their coordinates and are characterized by the values of the parameters in Y, U, and V.

Other characteristics of pixels also are possible. An empty set of pixels forms a trivial object. More complex objects are formed with the aid of several finite sets of operations, which determine the set of all objects in the given subject range model, and which may be constructed with the aid of several sets of elementary objects.

In the examined subject range model the following operations are used:

an operation of the product of objects—determines the object, consisting of all pixels common to them;

a quadratic sum operation—is determined as an object, consisting of all pixels of a minimal rectangular block that includes the given objects;

an operation for the construction of an additional object—determines the object, which includes all pixels not belonging to the object's set of pixels.

The operations may be reduced in such a way that the objects will be separate rectangular blocks, a set of non-intersecting rectangular blocks, or the entire image, from which one or several non-intersecting blocks were removed. The first set of objects is a substantial development of the construction of motion estimation on the basis of a discrete-cosine transform approach.

Another system for controlling operations is an extension of the system using motion estimation with the principal distinction that complex objects may be a combination of non-intersecting objects. Loosening this condition allows the construction of an even more general conceptual approach to the control of motion estimation. The class of supplemental objects allows one to more adequately solve the problem of selection of an initial set of blocks, with which construction of an optimal approximation of the images can be started with blocks from the previous and subsequent images.

Construction of a graph of the interaction and relationships of the blocks allows one to effectively solve the class of motion estimation problems of how to create a method of selection of the initial set of blocks of an interpolated type of image, from which the process of approximation of the images can be started with minimal error. In general, such a selection is not determined uniquely. However the uncertainty of the selection may be significantly reduced if one succeeds in finding a maximal quantity of blocks, arranged in a block of minimal size, the approximation of which is combined with maximal error. Thus three events are possible:

1. the size of the error is close to the level of the upper or lower threshold;

2. the size of the error significantly exceeds the threshold level;

3. there are several different values for the criterion of proximity for approximation of a block.

Analysis and isolation of these events is combined with the selection of the criterion for proximity of the approximating and approximated blocks. The criteria may have a simple single-criterion type of structure (i.e., the value of the criterion is determined by the values MSE on the pixel, PSNR on the pixel). However, the image brightness and color variety have different influence on the value of the integral criterion. Therefore, it becomes expedient to use criteria of the type:

S(I₁, I₂)=α₁S₁(Y₁, Y₂)+α₂S₂(U₁, U₂)+α₃S₃(V₁, V₂)

where α₁, α₂, α₃ are weighted coefficients that determine the degree of importance of the inclusion of differences for Y, U, V per pixel. The coefficients may be determined by a method of selection using iteration procedures for multi-criteria optimization.

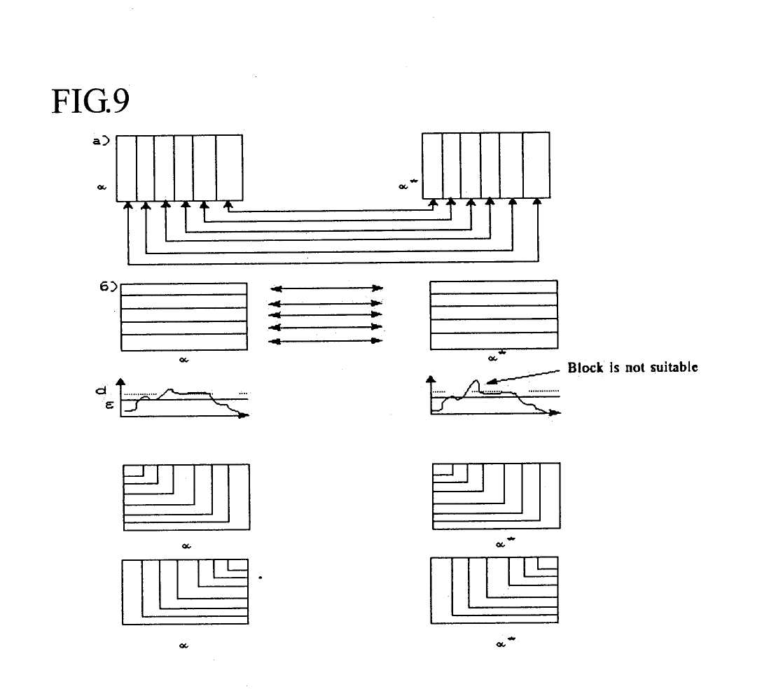

Integral criteria, which evaluate degrees of proximity of two blocks as objects of a scene, generally do not adequately reflect the given property. Therefore, dynamic values are used along with static values. On the basis of the dynamic approach an entire class of measurements of the proximity of two objects, presented as blocks, is constructed. For example, assume and * are two blocks, one of which is approximable, the other is obtained as a result of an approximation based on motion estimation. For the corresponding columns each of the blocks is calculated MSE (FIG. 9).

The sequence of sample values \overline{m}₁, . . . , \overline{m}ₖ are obtained. The proximity of blocks Bᵢ Bᵢ* will be greater, the lower the variance of the mathematical series is. One may use the statistics:

$$C = ( \frac{1}{k} {\sum }_{i = 1}^{k} {m}_{i} ) {\overline{σ}}_{m}$$

as a function of proximity. Other types of metrics yield a system of blocks embedded in each block per the particular law. (FIG. 9)

For each pair of corresponding blocks of the system of embedded blocks once calculates MSE (PSNR, SNR), and obtains the sequence of values μ₁, . . . , μ_{k.} The mean and the variance of the obtained series give rise to yet another function of proximity of such a type:

$$ϕ = ( \frac{1}{k} {\sum }_{i = 1}^{k} {μ}_{i} ) \overline{{σ}_{μ}} ,$$

reflecting the degree of proximity of the blocks. The given method creates a library of functions of the proximity of blocks. Each function reflects the particularity of the interaction of objects that belong to the given block of blocks of the subject realm. The necessity of building a set of functions of proximity of the approximated and approximable blocks is conditioned by the fact that any such function is an integral characteristic of the coefficients or squares of differences Y, U, V for corresponding pixels. The integral characteristic reflects the determined structural qualities of the image connected to the block.

By its size, one may form an opinion only about the degree of transfer of the structural quality from the approximated block to the approximable. On the strength of this it is necessary for any object represented as a block to isolate a set of all of its structural qualities, which describe it uniquely or with necessary completeness. The structural qualities describe the geometry of sub-objects, the relations between them, their mutual arrangement, light and shade, flashes and other artifacts arising from scene to scene.

To reflect the geometric qualities of the sub-objects, further splitting into more simple objects may be necessary. The inter-connection between the set of all objects belonging to one block is described by the sub-graph of the graph of inter-connections of all objects of the scene. Each element of such a sub-graph is placed in accord with a selection of criteria (proximity functions) that allow one to sufficiently precisely identify the proximity of the approximable and approximated blocks.

Each object, represented as a block, is described by a vector criterion for the evaluation of proximity to other blocks

(S₁(i, j, lᵢⱼ, lⱼᵢ, Oₘ_{ᵢ}ₙ_{ⱼ}), . . . , Sₖ(i, j, lₖᵢ, lₖⱼ, Oₘ_{ₖ}ₙ_{ₖ})),

where (i, j) are coordinates of the upper left pixel of the approximable block, (lₖᵢ, lₖⱼ) are coordinates of the upper left pixel of the approximated block for sub-object Oₘₖₙₖ, that belongs to the given object, represented by approximable block Oᵢⱼ.

A sufficiently simple method for construction of a system of functions Sₖ is based on a block structure. Moreover, each object is examined as a minimal rectangular block, which contains the given object with the matrix assigned to it, which contains only 0 and 1. An element of the matrix is equal to one if the corresponding pixel does not belong to the object and Zero if it does belong. Then for the sub-object Oₘₚₙₚ of object ij the function S₁ for the pixel-by-pixel comparison of the proximity of the blocks has the form:

$${S}_{1} ( i , j , {l}_{qi} , {l}_{qi} , {O}_{{m}_{p} {n}_{p}} ) = {⟨ {\sum }_{l = 1}^{n} {\sum }_{s = 1}^{n} a ( i , j ) ( s , l ) {( x ( i , j ) ( s , l ) - \tilde{x} ( {l}_{i} , {q}_{i} ) ( s , l ) )}^{2} ⟩}^{1 / 2} ,$$

where a(ij) is the matrix of object O(mₚ, nₚ) from 0 to 1.

The vector (s₁, . . . , sₖ) is verified on the fulfillment of the condition (s₁<δ₁, . . . , sₖ<δₖ), where limits for δᵢ are given, proceeding from the requirements placed on the characteristic of approximation. The lower the error of approximation, the lower the values of the limits are. If all conditions are fulfilled for a block (l_{qi}, l_{qj}), then it is selected as an approximating block. If a condition is not fulfilled for some subset, then two approaches are possible:

A solution is adopted by group selection method (in this particular case by the “polling” method). Here it is proposed that all conditions have equal value. A positive solution is adopted in the situation where more than one half of the conditions are fulfilled. If nonetheless conditions do not have equal value, then a vector of weights (β₁, . . . , βₖ) is selected empirically. A solution is obtained by means of summing the weights for those inequalities, which are fulfilled. If the sum of the weights is larger than the sum of the weights of the non-fulfilled inequalities, then a positive solution about the approximation is adopted.

In the event of a negative solution a review of all vectors (s₁, . . . , sₖ) is made for different approximable blocks for all possible values of the vectors of displacement of the blocks. From the entire set of solutions the sub-set of quasi-optimal solutions is selected. Assume min Sᵢ. Then the set of all approximable blocks for which |min Sᵢ-Sᵢ₁|<εᵢ is adopted to name the set of quasi-optimal solutions. The combination of quasi-optimal solutions relative to all criteria yields a full set of quasi-optimal solutions.

Multivariate integral criteria, as well as univariate criteria, do not guarantee that approximating blocks that correspond to the smallest values for the criterion of proximity of the blocks are not always the best approximating blocks. This event is conditioned as well upon the stochastic character of the criteria as well. A method was developed for seeking the best approximating block by means of analysis of the set of quasi-optimal solutions.

In the event that there is not one approximating block, for which this complete condition is met:

(s₁<δ₁, . . . , sₖ<δₖ),

or a weaker condition, based on the principle of group selection, the method proposes the examination of two cases.

In the first case this complete condition is fulfilled:

(s₁>>δ₁, . . . , sₖ>>δₖ),

or the weaker condition:

(sᵢ₁>>δᵢ₁, . . . , s₁ₚ≧δᵢₚ)

One may confirm that the block contains within itself sub-objects, which are poorly approximated by any other blocks from the preceding or following frames. In this case a method of re-coding such blocks is used. Either separate blocks of 16×16 or groups of compactly distributed blocks, which are covered by a minimal block of either 32×32 or 64×64, are subject to re-encoding.

In the second case either this complete condition is fulfilled, by:

(s₁>δ₁, . . . , sₖ>δₖ)

or the reduced condition:

(s₁<δ₁, . . . , sₖ<δₖ) (|sᵢ-δᵢ|<εᵢ, . . . , |sᵢₚ-δᵢₚ|<εᵢₚ),

resulting from the group selection procedure.

Analogous to the first case, one may confirm that the block contains sub-objects, which are poorly approximated by any other blocks. However unlike the first case, the difference is close to the limit level per the corresponding criterion. The characteristic of approximation may be substantially improved with the help of the procedure of quadratic splitting of blocks, which essentially isolates sub-blocks of the approximable block.

The developed method allows one to control with motion estimation procedures in such a way that the necessary degree of compression and the required level of quality of the visual perception of the image are simultaneously guaranteed.

The Method for control with motion estimation contains the following steps:

Step 1. A dynamic sequence of images is classified according to the degree of the correlation relationship between them on a subsequence with similar scenarios.

Step 2. A scenario (i) is selected from within the dynamic sequence of images.

Step 3. An image (j) is selected from within the scenario (i).

Step 4. A strategy for global control with motion estimation for a class subsequent of images that form one common scenario is selected.

Step 5. A local strategy for control with motion estimation for the current scenario (i) and image (j) is selected.

Step 6. The parameters for the local strategy of control with motion estimation and their adjustment in the process of encoding blocks of the current scenario (i) are set.

Step 7. Assume that i is the number of the current scenario and j is the number of the encoded (approximable) image (frame).

Step 8. A graph of the interconnections of the relationships of the objects of image j and scenario i is constructed.

Step 9. Block j and scenario i, are encoded in accord with the selected methods for global and local strategy of calculating the inter-frame interaction (motion estimation).

Step 10. If j is the number of the final image of scenario (i), the quality of the compression for the scenario (j) is then verified as follows:

If the quality satisfies the given condition, one can assume i=i+1 and j=1, and move to step 3. If the quality does not satisfy the given condition, change the setting of parameters of global local strategies and transfer to step 6. If j is the number of the last image of the last scenario i one evaluates the quality of the compressed video through the entire system of controlled parameters: PSNR(MSE), the dispersion of PSNR(MSE) according to coefficients Y, U, V, an expert evaluation of the video quality, the bit rate et alia. If a function of such values satisfies the given requirements, then the work of the algorithm is confirmed, otherwise one reconstructs the parameters for the global and local strategies taking into consideration the results obtained.

Classification of the video film images:

If (F₁, . . . , Fₙ) is the sequence of all frames of a video film, and the dimension of the frame is in pixels. One can evaluate the relationship between adjacent frames by means of a correlation coefficient of the type

$$r ( {F}_{i} , {F}_{j} ) = \frac{1}{m \cdot n} {\sum }_{j = 1}^{n} {\sum }_{i = 1}^{m} ( {f}_{ise} - \overline{{f}_{i}} ) ( {f}_{ise} - \overline{{f}_{j}} ) / \sqrt{\overline{{D}_{i}} \cdot \overline{{D}_{j}}} ;$$

$$where$$

$$\overline{{D}_{i}} = \frac{1}{m \cdot k} {\sum }_{j = 1}^{n} {\sum }_{i = 1}^{m} {( {f}_{ise} - \overline{{f}_{i}} )}^{2} ;$$

$$\overline{{D}_{j}} = \frac{1}{m \cdot k} {\sum }_{j = 1}^{n} {\sum }_{i = 1}^{m} {( {f}_{ise} - \overline{{f}_{j}} )}^{2} ;$$

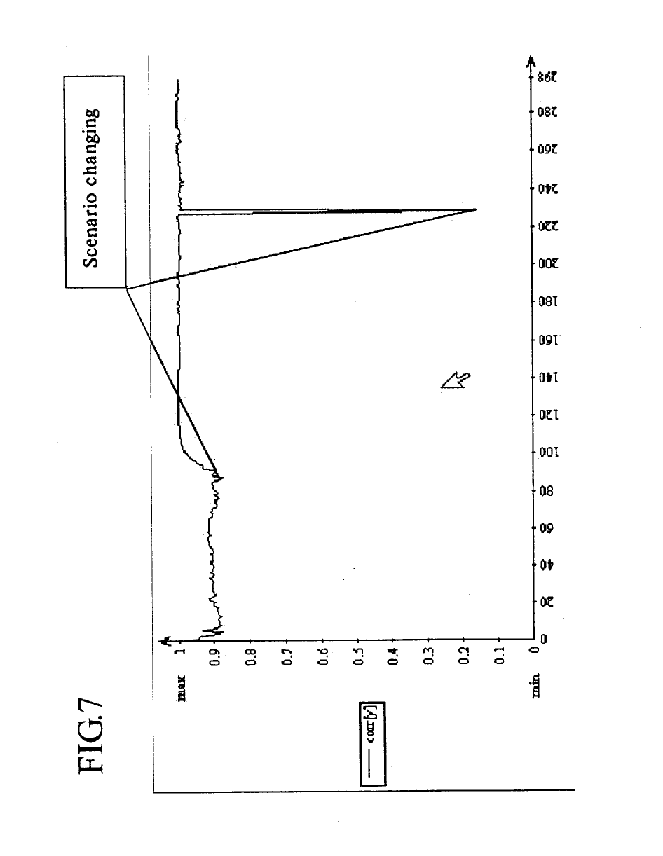

If the adjacent frames are strongly correlated between themselves, then r(Fᵢ, Fⱼ) takes on significance for such images, as a rule, within the limits 0.5≦r≦1. A real graph of the change of the correlation coefficient of the images of a test film “Boat” from the Panasonic company is shown in FIG. 7.

On the curve, two regions of relatively low values of r are visible, which split the entire set of video frames into three scenarios:

the boat with fishermen in front of harbor equipment;

the beach;

a pile of beach hats.

Thus, the regions of the minimum of the function r(Fᵢ, Fᵢ₊₁) determine the simple splitting of the film into three scenarios. Instead of a correlation function an Euclidean metric, or any other, may be used. However, it has been found that the correlation coefficient is the most convenient evaluator of the degree of inter-frame interaction.

The selection of a global strategy for control with motion estimation procedures:

The strategy for control by inter-frame interaction is determined by the distance between the nearest reference frames. The distance may be fixed as well as variable. In the latter case it is customary to talk about the adaptive model for the arrangement of the reference frames. In the current invention such a model is not considered. With a fixed distance between reference frames, its size is determined by the values of the correlation coefficient r(Fᵢ, Fⱼ₊₁). The value at which r(Fᵢ, Fⱼ₊₁)>0.5 and r(Fᵢ, Fⱼ₊₁₊₁)>0.5 is adopted as the optimal distance between reference frames. For control with evaluation of inter-frame interaction it is necessary to select a model for the coding (approximation) of the current frame on the basis of one or two reference frames and groups of consecutive previous encoded frames. The distance between the encoded frame and the number of the considered previous encoded frames is referred to herein as the depth of the encoding. The model of control is called two-sided if in the encoding of any frame the left and right reference frames are used, and one-sided if one of the reference frames is considered.

The depth of the encoding is determined by the depth of the strong correlation relationship between frames. Let r(Fᵢ, Fⱼ₊₁)>α, . . . , r(Fᵢ, Fⱼ₊ₖ)>α, but r(Fᵢ, Fᵢ₊ₖ₊₁)<α, where δ<α for any Fᵢ between the given reference frames, and δ is the mean value of the correlation coefficient between frames, placed between the selected reference frames. In FIG. 4 examples of different models for the global control of motion estimation are shown.

The correct selection of a model for control with inter-frame interaction significantly influences the quality of compression of the images. When practicing the current invention, it is recommended that one select a model for global control of motion estimation within the limits of one scenario. Cases where it is necessary to implement a repeat encoding after compression of the video film, whereby separate models for global control are replaced by others, are not excluded. A high value for the correlation coefficient, dispersed at great depth to the right or the left of the central image between two reference frames may serve as the basis for adoption of such a solution.

A model for local control with inter-frame interaction:

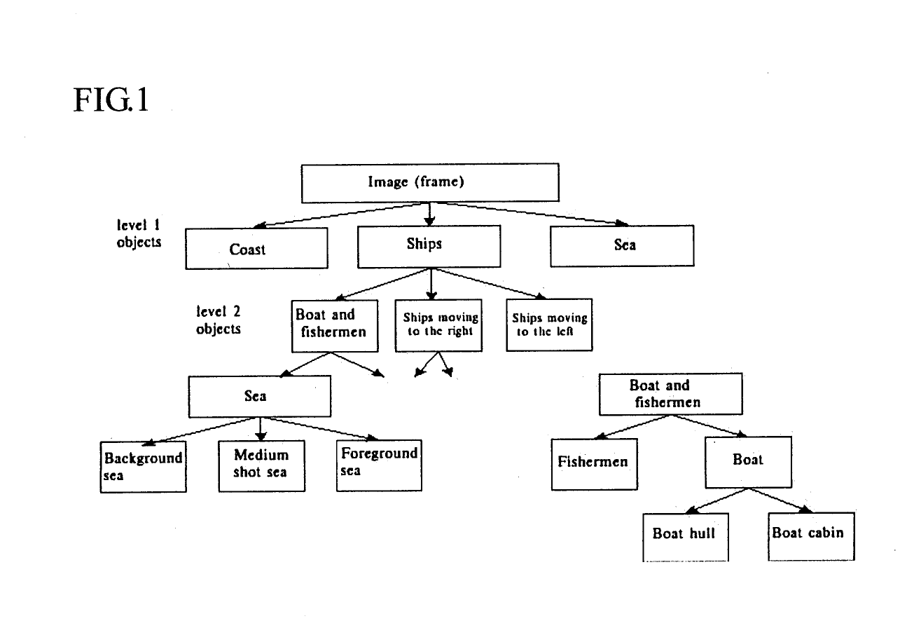

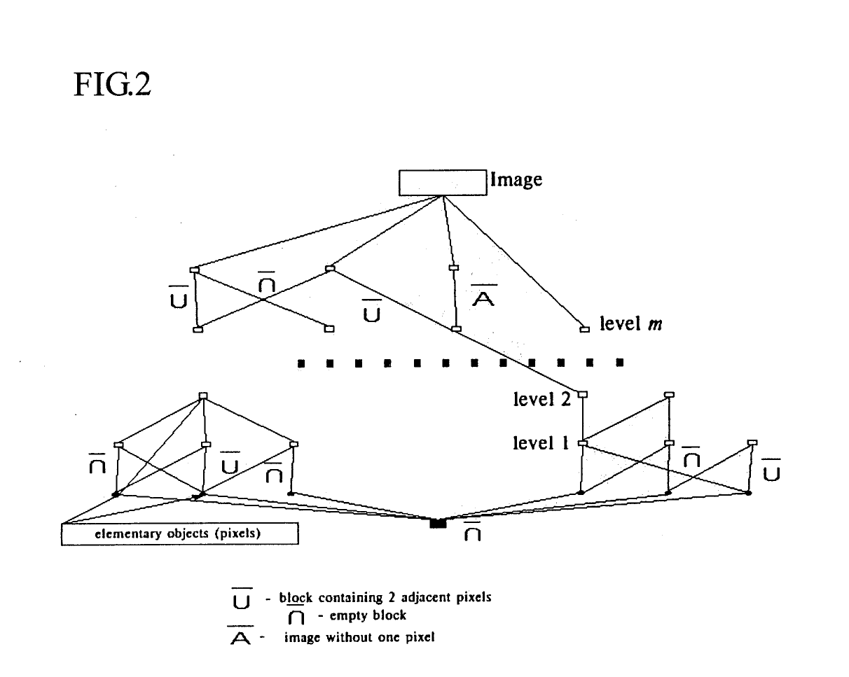

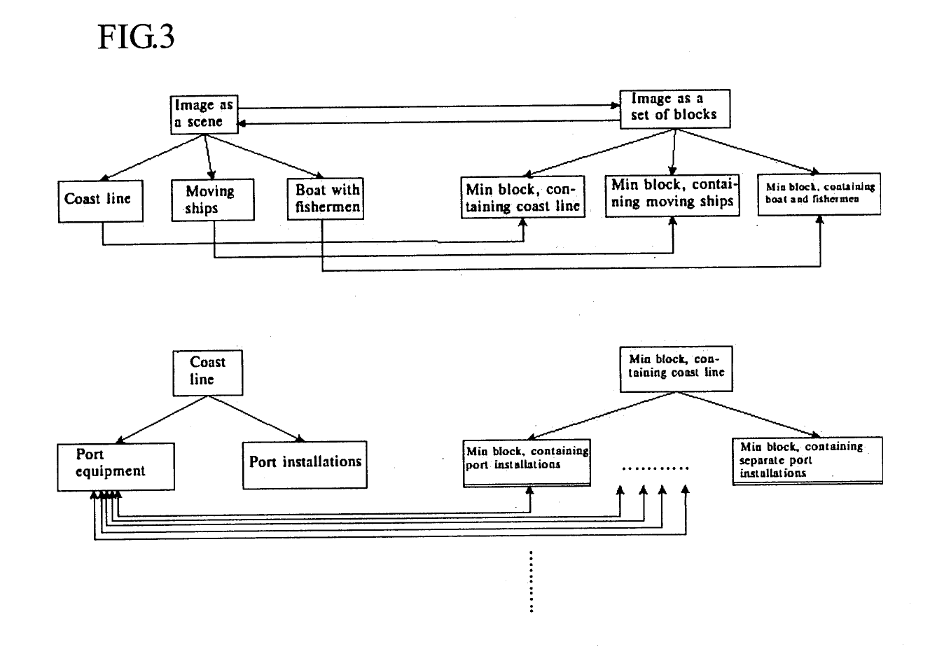

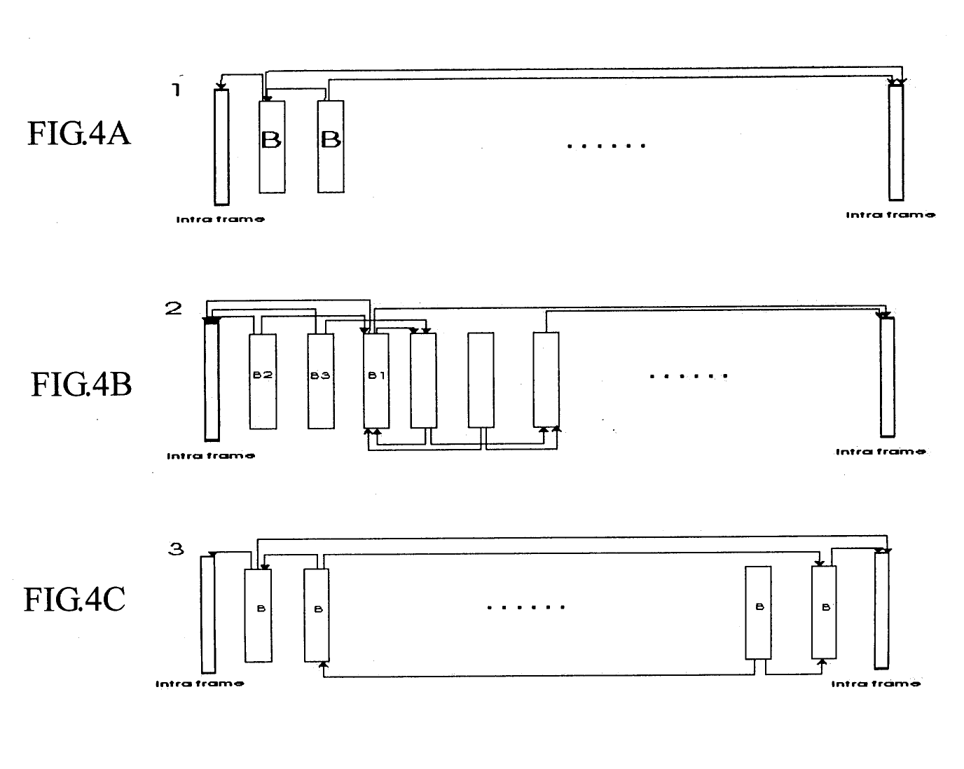

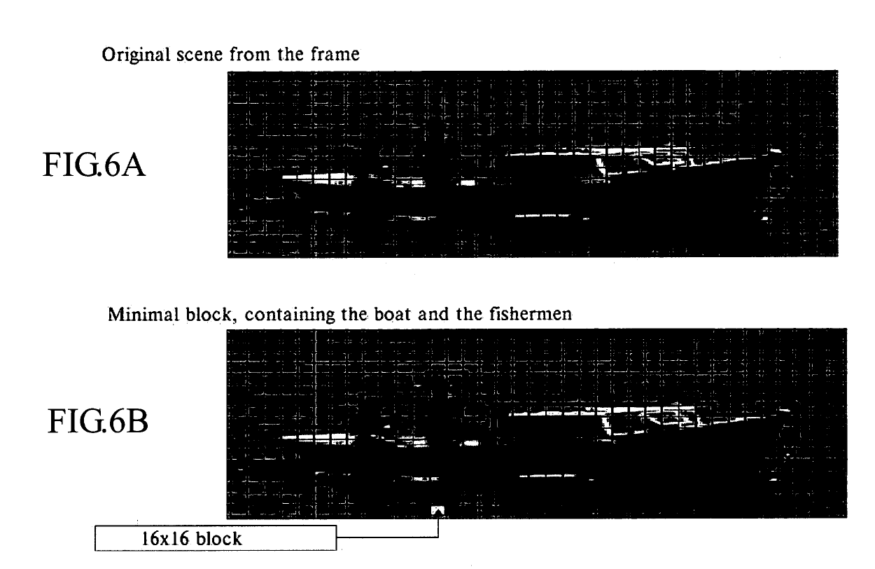

With construction of a strategy for local control with motion, it is necessary to select initial blocks from which coding per the determined strategy starts. Selection of an initial block measuring 16×16 or a group of blocks significantly influences the obtained results. To select a quantity of blocks covering that part of the image which is important for visual perception. For resolution of this task we construct a graph of the scene of the approximable image. In FIG. 1 different variants of analysis of the same scene are shown. From all possible descriptions of the structure of the scene the variant where the key object is presented in the form of an independent element, representing a minimal block is selected. In FIG. 6 a boat with fishermen is show, which is present in all frames of the first scenario.

It is important that when selecting the key object all elements present in it have the same spatial depth. Non-fulfillment of this condition, as a rule, leads to the formation of multiple artifacts. After construction of a graph of the scenes a local strategy for the control by motion estimation, which contains the following steps is used:

Step 1. Selection of an initial block, belonging to an isolated object, from which its approximation of the images, determinable by the global model of motion estimation with blocks, begins.

Step 2. A selection from the library of functions that determine the degree of proximity of the approximating and approximable blocks of a set of functions representing the vector sum of the character of the approximation.

(S₁(i, j, lₛ, l_{q}, Oₘ_{ᵢ}ₙ_{ⱼ}), . . . , Sₖ(i, j, lₛ, l_{q}, Oₘ_{ₖ}ₙ_{ₖ})),

Step 3. Selection of the optimal plan for review of the blocks through the vector of displacement (lₛ, l_{q}) on the approximating image, and for each function S₁, . . . , Sₖ one can select a graph reflecting the dynamic of change of these functions in the process of the search for blocks that correspond to the quasi-optimal values.

Step 4. Selection of a procedure and conditions for re-encoding of separate blocks or groups of blocks.

Step 5. Selection of a procedure for quadratic splitting of the blocks.

Step 6. Selection of a function for removal of artifacts.

The setting of parameters for a local procedure for control with motion estimation:

The setting of parameters for a local strategy of motion estimation includes the selection of an initial coding object, a minimal block containing it and an initial block of 16×16 pixels, from which the encoding process begins. Thus two approaches are possible. The selection of these elements is made by the operator, which controls the video conversion process and the quality of the regenerated images. A formal approach to the selection of these parameters is possible. For this the computing complexity of the dynamic of the change of scenes is evaluated on the basis of the complexity of the correlation matrix between all pairs of images of the given set. One can select an object possessing the greatest computing complexity of the dynamic of change, and in it analogously a block with the maximal computing complexity.

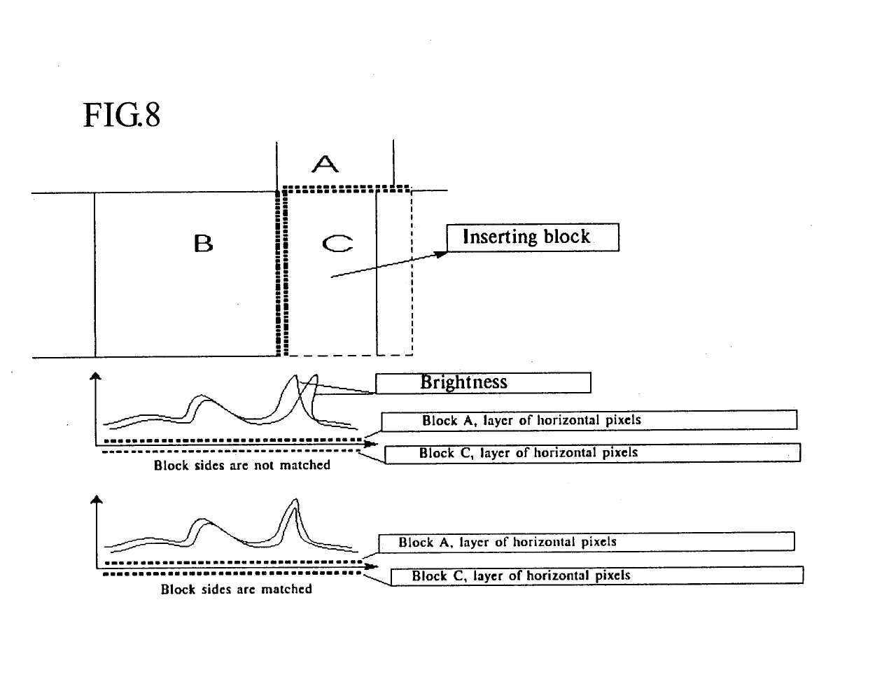

Any object may be broken down into simpler objects. From a theoretically plural point of view, objects of a block containing the given object are any connected subsets of pixels. In FIG. 8, examples of simple objects of the approximating and approximable blocks and the correspondences between them are shown. Such objects possess an independent value in two aspects. First, with their help it is easier detect the independently moving fragments of the foreground and background. This is manifested in the development of displacements of blocks of vertical or horizontal pixels, if a portion of them is connected with the foreground and a part with the background. Secondly, aggregates of such elementary object verification of the degree of proximity of the two blocks.

For this, a correspondence is established between the corresponding simple objects of the approximable and approximating blocks. For pairs placed in correspondence, the values of the function of proximity are calculated. A sequence of values m₁. . . . , mₖ of the estimations of MSE or PSNR is obtained. If the dispersion Dₘ<ε, where ε>0 is of a sufficiently low value, then these objects practically correspond.

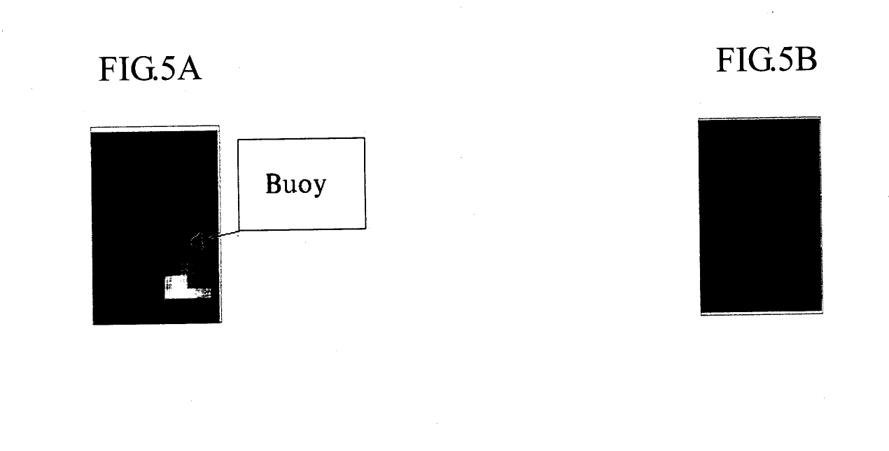

When the sequence m₁, . . . , mₖ has a peak, then this speaks to the fact that, regardless of the proximal or corresponding values of MSE or PSNR, the given blocks contain objects which differ significantly. In FIG. 5(a) a block from a video scene is shown that includes the sea and a buoy, while in 5(b) only the sea is in the same place in the image, but the buoy is missing. In this case the difference MSE for these blocks is not very great. Methods for resolving the problem of artifacts, which hereby arise, and methods for their removal are not considered in this invention.

For systems of evaluating functions of proximity S₁, . . . , Sₖ the rule for decision making about the proximity for the blocks, that is acceptable for coding is selected.

If the best variant is selected for coding of the given block by means of its approximation with another block, then after this it is necessary to verify the consistency of the borders of the given block with adjacent blocks. A sufficiently simple model for verification of the consistency is shown in FIG. 8. If the functions of brightness U and V correspond to two adjacent columns of pixels, then the block is assumed to be consistent along its borders well as in its internal structure.

Selection of the approximating block is completed:

In the event of the non-correspondence of borders, the solution for the approximation (coding) may not be adopted. In such events the adoption of either procedures for the quadratic splitting of the block or the removal of the artifact resulting from the non-correspondence of the borders is necessary. The movement of parts of a block in different directions may be one such artifact. The quadratic splitting procedure permits one to sufficiently simply remove the given artifact.

A procedure for the re-encoding of blocks:

In the event that for all variants of the approximation of a given block with another all variants of the solution are significantly noted for a large side in relation to the line of transition, it is necessary to re-encode such a block. If in the vicinity of the given block other blocks are missing that require re-encoding, then the given block is re-encoded independently.

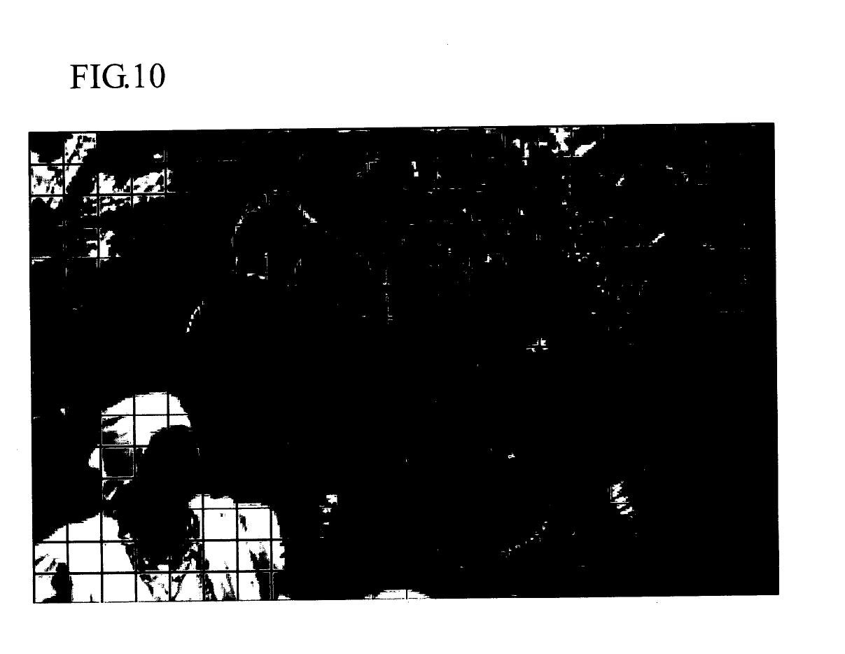

When blocks that require re-encoding form a compact group, then a minimal block that contains them is isolated. If the portion of blocks that require re-encoding is greater than 50%, then the separated minimal block is fully re-encoded. This guarantees an increase in the quality of the coding, including the removal of the block structure from the encoded image. In FIG. 10 an example is shown of the distribution of blocks requiring re-encoding and consolidated blocks of re-encoding. The re-encoding strategy requires careful control of the deposit of the re-encoded blocks into the bulk of the code of the approximable image. The covering by larger blocks must be fulfilled in such a way as to thereby minimize the length of code of the re-encoded blocks.

Procedure for quadratic splitting of blocks:

In U.S. Provisional Patent Application No. 60/347,343, entitled “The Enhanced Aperture Problem Solving Method Using Displaced Center Quadtree Adaptive Partitioning,” filed Jan. 9, 2002, one model for the quadratic splitting of blocks with the goal of significantly increasing the quality of approximation was proposed. The disclosure of that application is incorporated herein by reference.

If one examines the construction of quadratic splitting of more blocks in the case where re-encoding does not yield the necessary result. The method proposed in the referenced application may be generalized in the case of large blocks. By using the method introduced in this patent for each variant of splitting, the effectiveness of the use of each of them to improve the approximation quality of the separated block may be verified. In comparison with 16×16 blocks the number of splitting variants is significantly larger. The exhaustive search for all variants and their analysis, from a computation point of view presents an NP-full problem. To reduce the number of variants in the set a method for analysis of the variants by means of the sequential transition from simple splitting variants to splitting variants with a complex structure is used.

The results of the encoding of complex test films from the “Panasonic” company show that in several cases, the splitting of large blocks into non-standard blocks is a serious alternative method for the full re-encoding of large blocks.

The methods disclosed in the current application can be executed or preformed in a computer, other microprocessors, programmable electronic devices or other electronic circuitry. The methods can be loaded into the above devices as software, hardware, or firmware. The given methods can be implemented and programmed as discrete operations or as a part of a larger video compression strategy.

### INDUSTRIAL APPLICABILITY

The invention has applicability to the field of video compression. In compliance with the statute, the invention has been described in language more or less specific the method of practicing the invention. It is to be understood, however, that the invention is not limited to the specific method shown or described, since the means and construction shown or described comprise preferred forms of putting the invention into effect. The invention is, therefore, claimed in any of its forms or modifications within the legitimate and valid scope of the appended claims, appropriately interpreted in accordance with the doctrine of equivalents.

What is claimed is:

1. A method for presenting a video film comprising the steps of;
a) presenting the video film as a dynamic sequence of scenarios;
b) presenting the scenarios as a sequence of scenes, each scene being replaced by another;
c) presenting the conditions of a subject field in a given moment of time, by means of adequate description of a set of objects interacting with each other; and
d) presenting the objects of a scene with the required degree of adequacy on the basis of a theoretical-multiple description in terms of pixels, their properties and the relationships between them.

2. A method for controlling compression of a video film having a dynamic sequence of images, comprising the steps of:
a) classifying the dynamic sequence of images according to the degree of the correlation between the same images in similar scenarios;
b) selecting a scenario (i) from within the dynamic sequence of images;
c) selecting an image (j) from within the scenario (i);
d) selecting a strategy for global control with motion estimation for a class subsequent of images that form one common scenario;
e) selecting a local strategy for control with motion estimation for the current scenario (i) and image (j);
f) setting the parameters for the local strategy for control with motion estimation during the process of encoding blocks of the current scenario (i);
g) assuming that (i) is the number of the current scenario and (j) is the number of the encoded image;
h) constructing a graph of the interconnections of the relationships of the objects in image (j) and scenario (i); and
i) encoding image (j) and scenario (i) with the selected strategy for global control and local strategy for control with motion estimation.

3. The method of claim 2 wherein steps c through i are repeated for all images within the selected scenario.

4. The method of claim 2 wherein if (j) is the final image of scenario (i), the quality of the video compression for scenario (i) is verified by checking to see if a predetermined condition has been met.

5. The method of claim 4 wherein if the predetermined condition has not been met, the setting for the parameters for the local strategy for control are adjusted and steps c through i are repeated for all images within the selected scenario.

6. The method of claim 4 wherein if the predetermined condition has not been met, a different local strategy for control is selected and steps c through i are repeated for all images within the selected scenario.

7. The method of claim 2 wherein if (j) is the final image of scenario (i) and (i) is the final scenario of the dynamic sequence of images, the quality of the video compression for the entire sequence of dynamic images is verified by checking to see if a predetermined condition has been met.

8. The method of claim 7 wherein if the predetermined condition has not been met, the setting for the parameters for the strategy for global control are reconstructed, and steps b through i are repeated for all scenarios (i) and images (j) within the dynamic sequence of images.

9. The method of claim 2 wherein the dynamic sequence of images is classified by evaluating the relationship between adjacent frames on the basis of a correlation coefficient.

10. The method of claim 2 wherein the dynamic sequence of images is classified by evaluating the relationship between adjacent frames on the basis of an Euclidian metric.

11. The method of claim 2 wherein the strategy for global control with motion estimation is selected within the limits of a single scenario.

12. The method of claim 2 wherein the local strategy for control with motion estimation comprises the steps of:
a) selecting an initial block of pixels;
b) selecting a set of functions representing the vector sum of the character of the approximation from a pre-defined library of functions that determine the degree of proximity of the approximating and approximable blocks;
c) selecting an optimal plan for review of the blocks through the vector of displacement on the approximating image;
d) selecting a procedure and conditions for re-encoding blocks;
e) selecting a procedure for quadratic splitting of the blocks; and
f) selecting a function for the removal of artifacts.

13. The method of claim 12 wherein the procedure and conditions for re-encoding blocks comprises the following steps:
a) determining whether it is necessary to re-encode a given block;
b) determining if there are other blocks, in the vicinity of given block, that require re-encoding; and
c) re-encoding the blocks.

14. The method of claim 12 wherein the initial block of pixels is selected from a key object isolated in a graph of the interrelationships of the objects in the approximal image.
